(19) United States
(12) Patent Application Publication
(10) Pub. No.: US 2012/0206492 A1
(43) Pub. Date: Aug. 16, 2012

(54) CONTROL TERMINAL DEVICE AND REMOTE CONTROL SYSTEM

(75) Inventor: Takayuki FUKUI, Osaka (JP)

(73) Assignee: PANASONIC CORPORATION, Osaka (JP)

(21) Appl. No.: 13/454,753

(22) Filed: Apr. 24, 2012

Related U.S. Application Data
(63) Continuation of application No. PCT/JP2011/003054, filed on May 31, 2011.

(30) Foreign Application Priority Data
May 31, 2010 (JP) 2010-123970
Jun. 8, 2010 (JP) 2010-130704

(51) Int. Cl. G09G 5/00

(52) U.S. Cl. 345/660

(57) ABSTRACT

Provided are: a receiving unit receiving a first operation script from a media server; a determination unit selecting a display size of an object as a component of an operation screen defined by the first operation script when the object is displayed in a wireless terminal device; and a script conversion unit changing the received first operation script to a second operation script in accordance with results of the selection by the determination unit and then executing the operation script. The determination unit selects a second display size which permits the wireless terminal device to display the object within predetermined update time and is smaller than a first display size defined by the first operation script, and the script conversion unit changes the display size of the object from the first display size to the second display size to thereby change the first operation script to the second operation script.

### CROSS REFERENCE TO RELATED APPLICATIONS

This is a continuation application of PCT Patent Application No. PCT/JP2011/003054 filed on May 31, 2011, designating the United States of America, which is based on and claims priority of Japanese Patent Application No. 2010-123970 filed on May 31, 2010 and Japanese Patent Application No. 2010-130704 filed on Jun. 08, 2010. The entire disclosures of the above-identified applications, including the specifications, drawings and claims are incorporated herein by reference in their entirety.

### BACKGROUND OF THE INVENTION

(1) Field of the Invention

The present invention relates to action of changing a script defining a GUI in a remote UI.

(2) Description of the Related Art

Known is a method (hereinafter referred to as remote UI) of controlling a media server, which performs operation by use of a GUI (Graphic User Interface) from a control terminal device, by use of the same GUI independently from a path of communication with the control terminal device.

In a case where a server device is operated by use of the remote UI, the control terminal device acquires from a media server a script related to the operation of this media server (hereinafter referred as operation script). Then the control terminal device can execute the operation script to thereby operate the media server.

Upon the operation by the remote UI, in a case where a transmission path between the control terminal device and the media server is slow, there arises delay in time at which the user actually operated the control terminal device and time at which the media server acts in accordance with this operation.

To solve the problem described above, as a conventional art, there is a technology such that on a transmission path with a satisfactorily high transfer rate for transmitting picture data of, for example, a display picture of a controlled computer, addition processing for shortening time of transferring the picture data described above is not performed, and on a transmission path with a low transfer rate, processing is performed on the picture data for more effective picture data transmission to thereby speed up a response time for an entire system (see Japanese Unexamined Patent Application Publication No. 2004-187062 in particular).

Moreover, there is a method of reducing a transfer data volume related to operability in a client device connected to a server device via a network (see Japanese Unexamined Patent Application Publication No. 2002-186060 in particular).

### SUMMARY OF THE INVENTION

In the remote UI, depending on device performance in the control terminal device, there arises a difference between actual operation time and action time. That is, in a case where an operation script is executed in the control terminal device, processing of executing the operation script in the control terminal device may be delayed for a reason, for example, that decoding of a picture file composing an object on the GUI can be performed only by software having relatively slow processing speed or that a graphic chip for speeding up drawing processing is not loaded.

To solve the problem described above, a control terminal device according to one aspect of the present invention is intended to change an operation script so that a display size of an object which is composed of a picture file and which is displayed on the GUI becomes an appropriate size in accordance with processing capability of its own device. The appropriate size refers to a display size of the picture file that can be updated, even with its own processing capability, within refresh time defined by the operation script. Moreover, the control terminal device according to the invention is intended to change the operation script before execution of this operation script so that a display size of at least some of objects other than the object to be operated on the GUI (hereinafter referred to as object to be operated) becomes smaller than that of the object to be operated.

A control terminal device according to one aspect of the present invention includes: a receiving unit configured to receive an operation script defining an operation screen; and a script conversion unit configured to reduce a display size of an object as a component of the operation screen defined by the operation script.

This permits the control terminal device to reduce the display size of the object defined by the operation script received from outside; therefore, even in a case where a screen of the control terminal device is larger than the operation screen of an external device, the operation screen can be displayed in the control terminal device.

A control terminal device in a system in which a controlled device and a control terminal device are connected according to one aspect of the invention receives from the controlled device an operation script defining an operation screen of the controlled device and then executes the operation script. The control terminal device includes: a receiving unit configured to receive from the controlled device a first operation script defining the operation screen; and a script conversion unit configured to generate a second operation script obtained by reducing a display size, in the first operation script, of an object as a component of the operation screen defined by the first operation script.

This permits the control terminal device to generate the second operation script by automatically reducing the display size of the object in the first operation script received from the controlled device; therefore, it is possible to generate an optimum second operation script in accordance with a capability of the control terminal device and a degree of significance of the object included in the operation screen.

A control terminal device according to one aspect of the invention in a system in which a controlled device and one or more control terminal devices are connected receives from the controlled device an operation script defining an operation screen of the controlled device and then executes the operation script. The control terminal device includes: a receiving unit configured to receive from the controlled device a first operation script defining that the operation screen is displayed in a first display size; a determination unit configured to, when an object as a component of the operation screen defined by the first operation script is a picture file, acquire a degree of significance of the object and determine whether or not the acquired degree of significance is equal to or lower than a predefined threshold value; and a script conversion unit configured to, upon determination that the degree of significance is equal to or lower than the threshold value, generate a second operation script by changing the display size of the object in the first operation script to a second display size smaller than the first display size.

This permits the control terminal device to reduce the display size only for the object with a low degree of significance included in the operation script; therefore, it is possible to reduce processing load required for displaying the operation screen without obstructing operation of the operation screen.

Moreover, the determination unit, upon determination that the degree of significance is equal to or lower than the threshold value, may read from the first operation script predetermined update time of the operation screen defined by the first operation script, may determine whether or not display of the object in the first display size can be completed in the control terminal device within the read update time, and upon determination that the display of the object cannot be completed, may change the display size of the object to the second display size in which the display of the object can be completed within the update time, and the script conversion unit, upon the determination by the determination unit that the display of the object in the first display size cannot be completed within the update time, may execute the second operation script obtained by changing the display size of the object in the received first operation script to the second display size.

This provides effect that even in a case where for the object included in the operation screen defined by the first operation script, its display in the first display size defined by the first operation script cannot be completed, executing the second operation script obtained by changing the display size of the object to the second display size permits completing update of the display within update time defined in the operation screen of the controlled device. Moreover, as described above, the operation script is changed so that the display size of the object agrees with the second display size smaller than the first display size, thus providing effect that processing volume required for rectangular transfer upon repeated refreshing can be reduced.

Moreover, the control terminal device, for each kind of the object, may store in a memory processing speed information indicating correspondence between the display size of the object and processing time required for displaying the object in the control terminal device, the determination unit may determine, by referring to the processing speed information, whether or not display of the object included in the operation screen in the first display size can be completed within the update time, and upon determination that the display cannot be completed within the update time, may select, from the processing speed information, the second display size in which the display can be completed within the update time in the control terminal device.

As a result of this, the memory stores for each kind of the object the processing speed information indicating the correspondence between the display size of the object and the processing time required for the display, thus providing effect that by referring to the processing speed information based on the kind of the object and the display size, it can easily be determined whether or not the display of the object can be completed within the update time read from the first operation script.

Moreover, for the object, a degree of significance may be defined for each condition to which the object applies, the determination unit may be further configured to, when the degree of significance of the object is lower than a predetermined threshold value, select, as the display size of the object, a second display size smaller than the first display size, and the script conversion unit may be configured to change the display size of the object in the operation script to the second display size.

This provides effect that various degrees of significance can be set for each condition to which the object applies, and also if the object applies to a plurality of conditions, their degrees of significance can be calculated to calculate an overall degree of significance, and it can be determined through only one comparison with the threshold value whether or not the operation script needs to be changed.

The determination unit may be configured to determine a kind of the object defined by the operation script, and when the object is a picture file, may determine that the degree of significance of the object is lower than the threshold value.

This provides effect that in a case where the kind of the object applies to a picture file requiring some processing time for typical display, the operation script can be changed so that the object is displayed with the display size reduced to the second display size.

The determination unit may be configured to, based on the operation script currently executed, when a plurality of the object are displayed as a plurality of options and one of the plurality of the object is highlighted for display indicating a selected state, determine that the object located closer to the object highlighted for display has a higher degree of significance and determine that the object located more distantly from the object has a lower degree of significance, and the script conversion unit may be configured to change the display size of the object in the operation script so that the object with the lower degree of significance has a smaller display size.

As a result, the operation script can be changed so that, of the plurality of objects displayed based on the second operation script currently executed, the object more distant from the object highlighted for display indicating a selected state is assumed to have a lower degree of significance and is thus displayed in a smaller display size. Therefore, the object with a lower degree of significance is displayed on a smaller scale, thus providing effect that processing load for displaying the operation screen can be reduced and also visibility of the operation screen can be improved.

Further, the determination unit may read from the first operation script update time of the object defined by the first operation script, and may select the second display size in which the display of the object is completed within the read update time, and the script conversion unit may change the first operation script to the second operation script so that the display size of the object agrees with the second display size.

This provide effect that even in a case where display update time is defined for each object, the display of the object can be completed within the defined update time.

Moreover, the determination unit may be configured to, when the operation screen is divided into a plurality of small regions and update time is individually defined for each of the small regions, select a second display size in which display of the object included in each of the small regions can be completed within the update time defined for the corresponding small region, and the script conversion unit may be configured to change the first operation script to the second operation script so that the display size of the object agrees with the second display size.

This provides effect that even in the case where the operation screen is divided into the plurality of small regions and the update time is separately defined for each of the small regions, the display of the object included in each of the small regions can be completed within the update time defined for the corresponding small region.

Moreover, the determination unit may be configured to, when the object defined by the first operation script is a picture decoded by software, determine that the degree of significance of the object is lower than the threshold value.

This provides effect that even in the case where the object defined by the first operation script is the picture decoded by the software, the display size of the object can be changed to the second display size to complete its display within the update time.

Moreover, the determination unit may be configured to determine that the degree of significance of the object displayed behind the different object is lower than the threshold value.

As a result, such an object that is displayed behind the different object is an object which is not to be operated and which has a low degree of significance. Therefore, in this case, there is low need for the user to check display contents of the object even when this object is displayed on a small scale; therefore, there is low possibility that the reduction to the second display size causes any problem. This provides effect that, by displaying the insignificant object in the second display size, processing load for displaying the operation screen can be reduced without any problem to improve visibility of the operation screen.

The invention can be realized not only as a device but also as an integrated circuit including a processor provided to such a device, as a method including steps of the processor forming this device, as a program causing a computer to execute these steps, or as information, data, or a signal indicating this program. Then these program, information, data, and signal may be distributed via a recording medium such as a CD-ROM or a communication medium such as the Internet.

The configuration described above makes it possible for the control terminal device to execute the operation script without delaying the picture file display processing. It also makes it possible for the control terminal device to promptly execute the operation script of the controlled device while maintaining the display size of the object to be operated.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1 is a pattern diagram showing one example of a remote UI system composed of a media server, a wireless terminal device, a TV monitor, a wireless router, and a remote controller;

FIG. 2 is a block diagram showing one example of hardware configuration of the media server in the remote UI system shown in FIG. 1;

FIG. 3 is a block diagram showing one example of hardware configuration of the wireless terminal device in the remote UI system shown in FIG. 1;

FIG. 4 is a functional block diagram showing one example of minimum configuration of the media server in the remote UI system shown in FIG. 1;

FIG. 5 is a functional block diagram showing one example of minimum configuration of the wireless terminal device in the remote UI system shown in FIG. 1;

FIG. 6 is a diagram showing one example of processing speed information stored in a memory of FIG. 3;

FIG. 7 is a flow chart showing operation script acquisition action in a wireless terminal device according to a first embodiment;

FIG. 8 is a flow chart of action performed upon operation script execution by the wireless terminal device;

FIG. 9 is a flow chart showing picture file analysis action and operation script change action in the wireless terminal device;

FIG. 10 is a diagram showing one example of an operation script received from the media server;

FIGS. 11A and 11B are diagrams showing one example of operation screens before and after a display of a picture file is changed by a script conversion unit;

FIG. 12 is an action flow chart illustrating action performed when a CPU acquires update time for picture file and determines a display size of the picture file according to a second embodiment;

FIG. 13 is a diagram schematically showing procedures of detailed operation script conversion processing in wireless terminal devices according to the first and second embodiments;

FIG. 14 is a flow chart showing picture file analysis action and operation script change action in a wireless terminal device according to a third embodiment;

FIG. 15 is a diagram showing a GUI displayed on the TV monitor upon execution of the unchanged operation script;

FIG. 16 is a diagram showing a GUI displayed on a liquid crystal display upon execution of the changed operation script;

FIG. 17 is a diagram showing a GUI displayed on the liquid crystal display upon the execution of the changed operation script;

FIG. 18 is a flow chart showing picture file analysis action and operation script change action in a wireless terminal device according to a fourth embodiment;

FIG. 19 is a flow chart showing picture file analysis action and operation script change action in a wireless terminal device according to a fifth embodiment;

FIG. 20 is a flow chart showing picture file analysis action and operation script change action in a wireless terminal device according to a sixth embodiment;

FIG. 21 is a flow chart showing operation script change action in a wireless terminal device obtained by combining together the fourth and fifth embodiments;

FIG. 22 is a flow chart showing operation script change action in a wireless terminal device obtained by combining together the fourth and sixth embodiments;

FIG. 23 is a flow chart showing operation script change action in a wireless terminal device obtained by combining together the fifth and sixth embodiments;

FIG. 24 is a flow chart showing operation script change action in a wireless terminal device obtained by combining together all the fourth to sixth embodiments; and

FIG. 25 is a diagram showing one example of an operation screen displayed on the liquid crystal display as a result of operation script change in a wireless terminal device according to a seventh embodiment.

### DESCRIPTION OF THE PREFERRED EMBODIMENTS

A control terminal device according to the embodiments is a control terminal device which, in a system connecting a controlled device and one or more control terminal devices, receives from the controlled device an operation script defining an operation screen of the controlled device and then executes the operation script. The control terminal device includes: a receiving unit which receives from the controlled device a first operation script defining that the operation screen is displayed in a first display size; a determination unit which, when an object as a component of the operation screen defined by the first operation script is a picture file, acquires a degree of significance of this object and then determines whether or not the acquired degree of significance of the object is equal to or lower than a predefined threshold value; and a script conversion unit which, upon determination that the degree of significance is equal to or lower than the threshold value, generates a second operation script obtained by changing the display size of the object in the first operation script to a second display size smaller than the first display size.

With the configuration as described above, the control terminal device, for the object as the component of the operation screen defined by the received first operation script, determines whether or not its degree of significance is equal to or lower than the predefined threshold value, and if the degree of significance of this object is equal to or lower than the threshold value, changes the first operation script so that the display size defined by the first operation script agrees with the second display size smaller than the first display size. This consequently makes it possible to reduce the display size of the object (for example, a picture file), which does not indicate significant contents of the operation screen, to the second display size to thereby reduce processing load of the control device required for, for example, picture processing for displaying the operation screen.

The control terminal device in this embodiment is a control terminal device that executes a first control script defining an operation screen of a first device different from its own device, and includes: a receiving unit receiving the first operation script from the first device; and a control unit changing the received first operation script to a second operation script and then executing the second operation script. The control terminal device, in accordance with update time, on the operation screen, of the object displayed on this operation screen and a display size of the object, changes the first operation script to the second operation script so that the display size of the object agrees with a display size (hereinafter referred to as second display size) smaller than a display size (hereinafter referred to as first size) defined by the first operation script.

The configuration as described above makes it possible to execute the operation script without delaying processing of displaying a picture file corresponding to the object.

Moreover, the update time in the above configuration may be update time of the operation screen.

The configuration as described above permits setting the display size of the object in accordance with at least the update time of the operation screen, which therefore makes it possible to execute the operation script without damaging operability.

Moreover, the update time in the above configuration may be set for each of the objects.

The configuration as described above makes it possible to set an appropriate display size for each object and also execute the operation script without delaying the processing of displaying the picture file corresponding to the object.

Moreover, the control in this embodiment may be configured to change the first operation script to the second operation script so that the update time becomes later than time of processing the object which time is predicted in accordance with the display size of the object.

The configuration as described above makes it possible to execute the operation script without delaying the processing of displaying the picture file corresponding to the object.

Moreover, the processing time in the above configuration may be predicted in accordance with the display size of the object and a compression format of the object.

The configuration as described above makes it possible to more appropriately set the display size of the object and also execute the operation script without delaying the processing of displaying the picture file corresponding to the object.

Hereinafter, the embodiments of the present invention will be described with reference to the accompanying drawings.

### First Embodiment

Hereinafter, the first embodiment will be described with reference to the drawings.

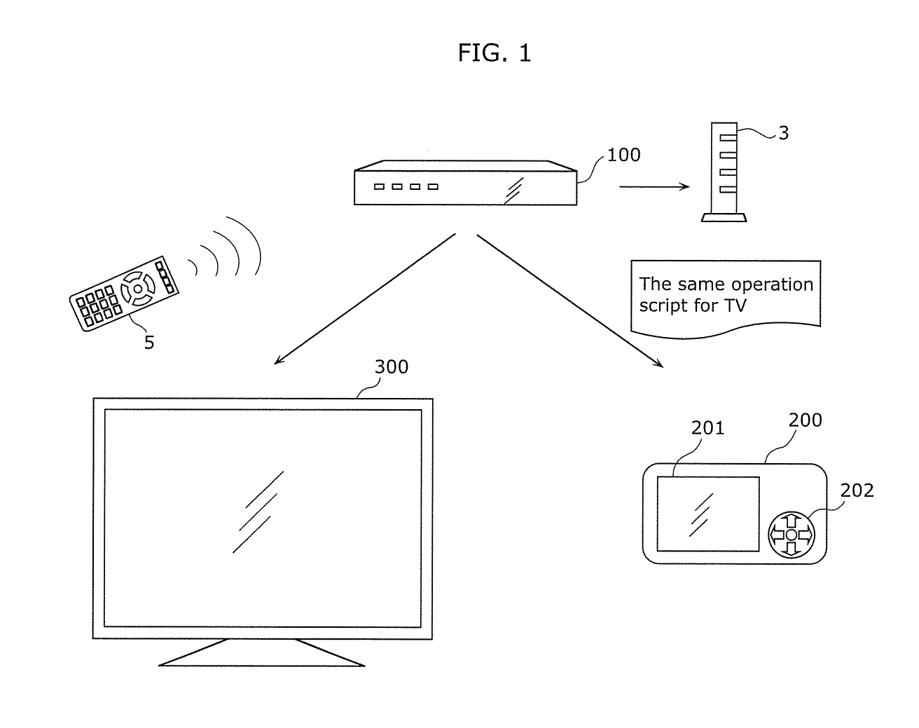

FIG. 1 is a block diagram showing one example of configuration of a remote UL system according to the first embodiment.

The remote UI system according to the first embodiment includes: a media server 100, at least one wireless terminal device 200, a TV monitor 300, a wireless router 3, a remote controller 5, etc. The media server 100 in this remote UI system is connected via, for example, the wireless router 3 or an IEEE1394 transmission cable to the wireless terminal device 200, the TV monitor 300, the remote controller 5, etc. The media server 100 displays on the TV monitor 300 an operation screen for controlling the media server 100 and also receives an operation signal corresponding to display of the operation screen inputted from the remote controller 5 to perform action corresponding to the received operation signal. Further, the media server 100 transmits and receives packet data to and from the wireless terminal device 200 via the wireless router 3.

The media server 100 accumulates contents data and an operation script that defines a GUI (Graphic User Interface) of its own device. The media server 100, in response to a request from the wireless terminal device 200, transmits the accumulated operation script as packet data to the wireless terminal device 200. This operation script is the same as an operation script that causes the TV monitor 300 to display the operation screen, and is so designed as to be easily operated when the operation screen is displayed in a display size of the TV monitor 300. Moreover, the media server 100, in accordance with an operation signal from the wireless terminal device 200, transmits the contents data as packet data to the wireless terminal device 200. The media server 100 can be realized by a communication device having a server function. For the media server 100, any device (for example, a blue-ray recorder or a blue-ray player, a set top box, or an NAS (Network Attached Storage)) connectable to a different device may be used.

The wireless terminal device 200 transmits to the media server 100 an operation script transmission request that requests for operation script transmission. Then the wireless terminal device 200 receives the operation script transmitted by the media server 100. Moreover, the wireless terminal device 200 executes the operation script to thereby operate the media server 100 through wireless communication. Then, as a result of the operation, the wireless terminal device 200 receives the contents data from the media server 100.

The wireless terminal device 200 is realized by a touch-operated display device, a PC connected with a display device, a portable phone, or the like, and any device capable of operation while displaying a GUI may be used. Configuration including at least a liquid crystal display 201 and an operation member 202 in the first embodiment will be described.

For the wireless router 3, for example, a wireless LAN (Local Area Network) based on the standard IEEE802.11 is used. Communication standards used for a communication path are not limited to the above standards and thus any communication standards of a communication medium of a wireless communication path may be used.

In the first embodiment, the media server 100 and the wireless terminal device 200 may be connected together through wire communication instead of using the wireless router 3.

Hereinafter, detailed configuration of the media server 100 and the wireless terminal device 200 will be described with reference to the drawings. Assume that in the first embodiment, processing of pairing the media server 100 and the wireless terminal device 200 for wireless communication has been completed and their address information has been exchanged therebetween.

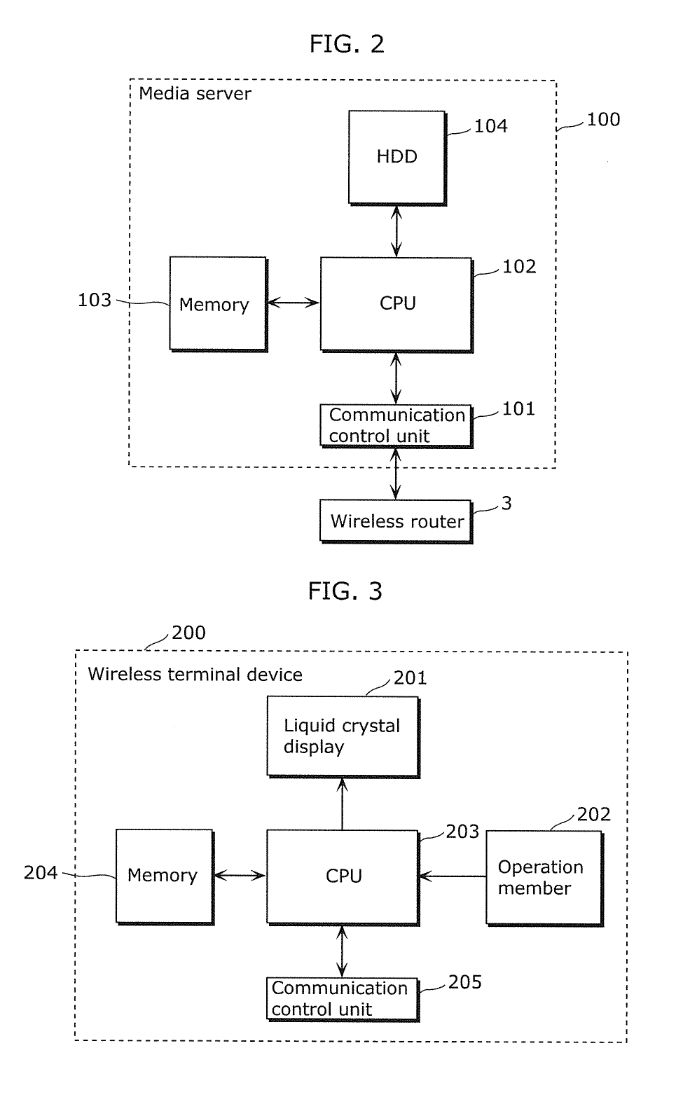

FIG. 2 is a block diagram showing one example of hardware configuration of the media server.

The media server 100 includes: a communication control unit 101, a CPU 102, a memory 103, and an HDD (Hard Disk Drive) 104.

The communication control unit 101 performs packet data transmission and reception to and from the wireless terminal device 200 via the wireless router 3. The transmission-related packet data is generated in the CPU 102. Moreover, the received packet data is outputted to the CPU 102. The communication control unit 101 is realized by, for example, a LAN controller.

The CPU 102 controls the entire media server 100. More specifically, the CPU 102, in accordance with an operation script transmission request transmitted by the communication control unit 101, generates packet data including this operation script, a picture file required upon execution of this script, and address information of the wireless terminal device 200. Then the generated packet data is outputted to the communication control unit 101.

Moreover, upon reception of the packet data including an operation signal by the communication control unit 101, the CPU 102 generates packet data in accordance with this operation signal. Then the CPU 102 outputs the generated packet data to the communication control unit 101. For example, the CPU 102 is configured to, upon reception of an operation signal defining contents data distribution, generate packet data including the contents data accumulated in the HDD 104 and the address information of the wireless terminal device 200.

The CPU 102 can be realized by a semiconductor element or the like. The CPU 102 may be formed by hardware only or may be realized by combining together the hardware and software. The CPU 102 can be realized by a microcomputer or the like.

The memory 103 accumulates at least an operation script and a picture file required upon execution of the operation script. The picture file corresponds to an object on the GUI expressed by the operation script. The picture file is a stationary picture compressed file. The picture file is compressed in a compression format such as a JPEG file or PNG. The picture file may be a stationary picture compressed file other than that described above. The memory 103 can be realized by, for example, a DRAM or a ferroelectric memory. Moreover, the operation script may include, for example, a moving picture file displayed by thumbnail instead of a picture file of the stationary picture.

The HDD 104 stores at least the contents data. The contents data is data which is reproduced in accordance with a reproduction instruction inputted from the operation screen and is viewed by a viewer upon the reproduction. The contents data is data compressed in a compression format such as an MPEG or an MP3. Permitted is configuration such that a nonvolatile recording medium such as a memory card is used instead of the HDD 104.

FIG. 3 is a block diagram showing one example of hardware configuration of the wireless terminal device.

The wireless terminal device 200 includes: the liquid crystal display 201, the operation member 202, a CPU 203, a memory 204, and a communication control unit 205.

The liquid crystal display 201 is a display device capable of displaying a video signal outputted from the CPU 203.

The operation member 202 accepts operation from the user. The operation member 202 includes, for example, up and down direction keys and a determine key as shown in FIG. 1. The operation member 202, upon the acceptance of the operation from the user, outputs to the CPU 203 a control signal corresponding to the operated key.

The CPU 203 controls the entire wireless terminal device 200. More specifically, the CPU 203, based on the control signal from the operation member 202, generates an operation script transmission request. The CPU 203 generates packet data including the generated operation script transmission request. The CPU 203 transmits the generated packet data to the media server 100 via the communication control unit 205.

Moreover, to the wireless terminal device 200, the packet data is inputted from the communication control unit 205. The CPU 203, in a case where the packet data includes an operation script and a picture file, stores these operation script and picture file into the memory 204. Moreover, the CPU 203, in a case where the packet data includes contents data, decodes the contents data and outputs it to the liquid crystal display 201.

Moreover, the CPU 203 stores therein or in the memory 204 data indicating a degree of significance of the object as a component of the operation screen defined by the operation script, and with reference to the stored degree of significance of the object, executes the operation script stored in the memory 204. This degree of significance may be stored as, for example, a list including an extension of a file indicating the object and a value of a degree of significance for this extension, or may be a value defined for each object through inputting by the user. Moreover, together with the operation script, the list of the degrees of significance defined for each object may be received from the media server 100. Further, as is the case with the degree of significance, a threshold value for judging whether the degree of significance is high or low may be previously stored inside of the CPU 203 or in the memory 204 upon, for example, shipment, or the one defined in accordance with inputting by the user may be stored, or it may be received from the media server 100. Then the CPU 203 displays results of the execution of the operation script on the liquid crystal display 201. That is, displayed on the liquid crystal display is the GUI of the media server 100. The user, based on the GUI displayed on the liquid crystal display 201, operates the media server 100. Upon operation of the operation member 202 by the user based on the GUI, the operation member 202 generates a control signal based on this operation and outputs it to the CPU 203. The CPU 203, upon reception of the control signal from the operation member 202, generates packet data including an operation signal corresponding to this control signal, and transmits it to the media server 100 via the communication control unit 205.

The CPU 203, based on information related to a speed of picture file processing in the wireless terminal device 200 (hereinafter referred to as processing speed information), changes the operation script. More specifically, the CPU 203 changes the operation script so that processing time for the picture file subjected to update processing during the display of the GUI is faster than update time for this picture file.

The memory 204 stores the operation script, the picture file, and the processing speed information. The memory 204 is realized by, for example, an HDD.

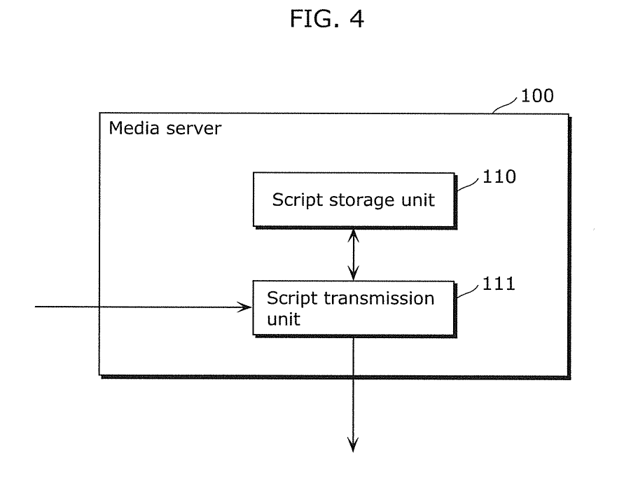

FIG. 4 is a functional block diagram showing one example of minimum configuration of the media server. The media server 100 includes at least a script storage unit 110 and a script transmission unit 111. The script storage unit 110 is realized by, for example, the HDD 104 or the memory 103 shown in FIG. 2, and stores the operation script of the media server 100. The script transmission unit 111 is realized by the communication control unit 101 and the CPU 102 shown in FIG. 2.

The script transmission unit 111 accepts the operation script transmission request from the wireless terminal device 200, reads the requested operation script from the script storage unit 110, and transmits the read operation script to the wireless terminal device 200.

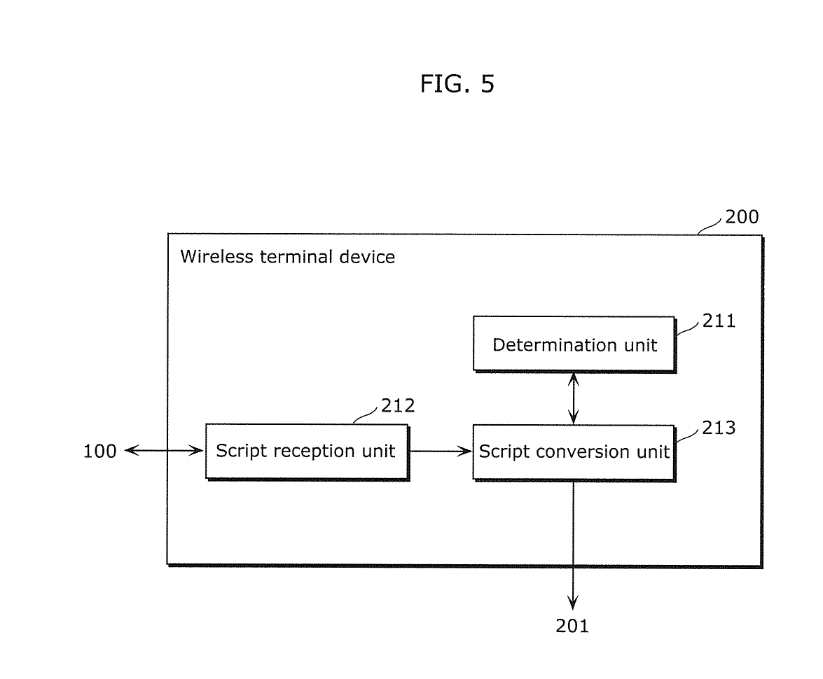

FIG. 5 is a functional block diagram showing one example of minimum configuration of the wireless terminal device. The wireless terminal device 200 includes at least a determination unit 211, a script receiving unit 212, and a script conversion unit 213. The determination unit 211 is realized by the CPU 203 and the memory 204 shown in FIG. 3, and based on the processing speed information stored in the memory 204, selects in which display size each object defined by the operation script received from the media server 100 is displayed.

A reason why the display size of each object is selected as described above is that the operation script received from the media server 100 is described on the assumption that it is displayed on a large screen of the TV monitor 300, and in a case where the entire operation screen is directly downsized in accordance with the size of the liquid crystal display 201 of the wireless terminal device 200, if hardware resources are poor (a speed of graphic processing of the CPU 203 is slow or memory regions are in short) when a kind of the object is a stationary picture or a moving picture, there is a possibility that the picture cannot be drawn within object refresh time. If the object cannot be drawn within the refresh time, there arises a problem that animation does not act smoothly or the picture is not displayed clearly.

The script receiving unit 212 is realized by the CPU 203 and the communication control unit 205 shown in FIG. 3, and in accordance with user operation input, transmits the operation script transmission request to the media server 100, and receives, as a response thereto, the operation script from the media server 100. The script conversion unit 213 is realized by the CPU 203 shown in FIG. 3, and in accordance with a result of the selection of the determination unit 211, changes the display size of each object defined by the operation script, and creates an operation script for the wireless terminal device 200 in which the display size of the object has been changed.

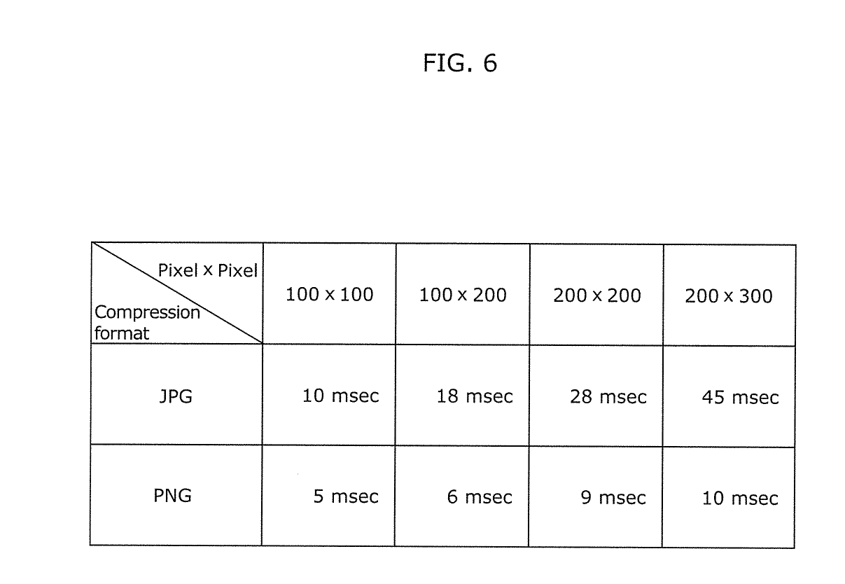

FIG. 6 is a diagram showing one example of the processing speed information stored in the memory. The processing speed information, as shown in FIG. 6, is table information in which processing speeds of the CPU 203 dependent on the display size of a picture file are mapped for respective compression formats of the picture file. For example, as shown in FIG. 6, the CPU 203 requires 10 milliseconds for processing a JPEG file with 100 pixels and 100 pixels. This processing speed information may be set at time of manufacturing the wireless terminal device 200. Moreover, it may be updated during operation script execution processing. The memory 204 can be realized by, for example, a DRAM or a ferroelectric memory.

The communication control unit 205 transmits and receives packet data to and from the media server 100. The communication control unit 205 outputs the received packet data to the CPU 203.

Next, the media server 100 and action in the wireless terminal device 200 will be described with reference to the drawings.

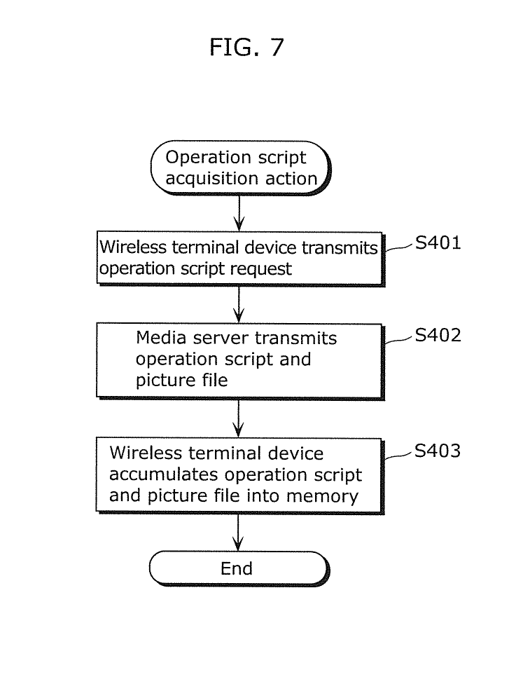

FIG. 7 is a flow chart showing operation script acquisition action in the wireless terminal device.

First, the wireless terminal device 200 makes an operation script transmission request to the media server 100. In a case where an ACK signal indicating that the operation script transmission request has been properly received is not returned from the media server 100, the wireless terminal device 200 makes the operation script transmission request again (S401).

If the operation script transmission request has been received, the media server 100 reads the operation script accumulated in the memory 103 and a picture file which the operation script describes to be displayed within the operation screen. Then the media server 100 transmits the operation script and the picture file as packet data to the wireless terminal device 200. If an ACK signal indicating that the operation script and the picture file have been properly received is not returned from the wireless terminal device 200, the media server 100 transmits this packet data again.

Next, the wireless terminal device 200 receives the packet data including the operation script and the picture file. Then the wireless terminal device 200 accumulates this operation script and this picture file into the memory 204 (S403).

The action from S401 to S403 may be executed upon pairing processing performed by the media server 100 and the wireless terminal device 200. Moreover, in a case where the user has performed operation via the operation member 202, the action from S401 to S403 may be performed for the first time.

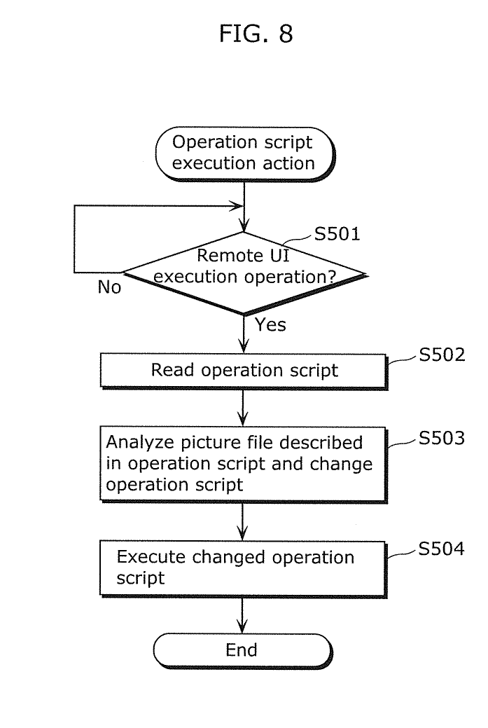

FIG. 8 is a flow chart showing action performed upon the operation script execution by the wireless terminal device.

If remote UI execution operation has been performed via the operation member 202, the CPU 203 executes the operation script accumulated in the memory 204. If the remote UI execution operation has not been performed, the CPU 203 remains waiting (S501).

If the remote UI has been executed, the CPU 203 reads the operation script from the memory 204 (S502).

After reading the operation script, the CPU 203 analyzes the picture file written in this operation script. Then the CPU 203, based on a result of this analysis, changes the operation script. More specifically, the CPU 203 changes the operation script so that when the picture file written in the operation script is displayed as an object on the GUI, this object is displayed on a reduced scale. For example, “picture file A is executed by 1920×1080” written in the operation script is changed to “picture file A is executed by 854×480” (S503). The picture file analysis action and detailed operation script change action performed by the CPU 203 will be described below.

Then the CPU 203 executes the changed operation script (S504).

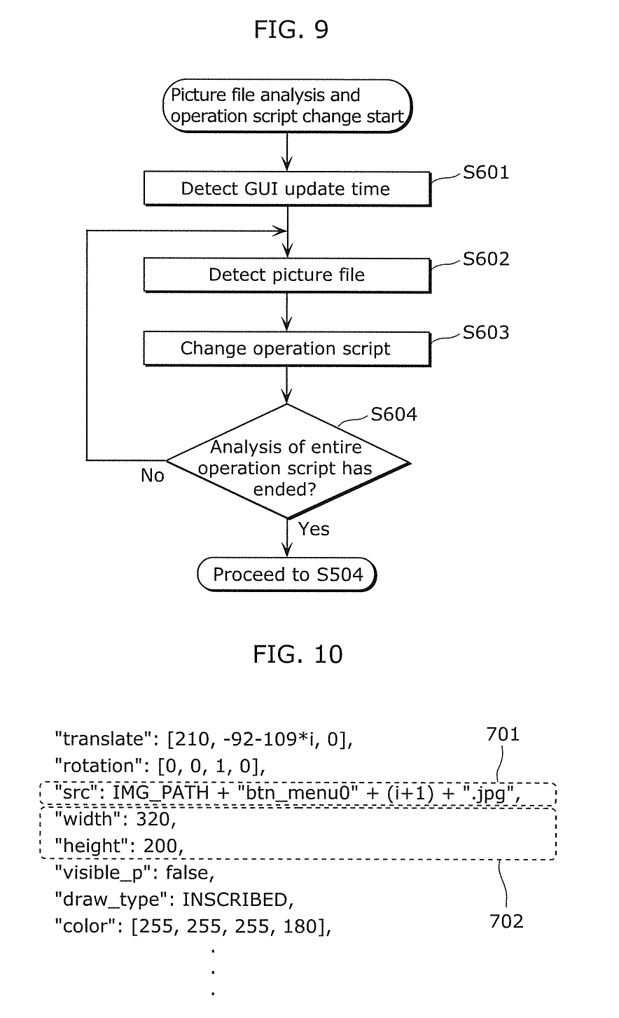

FIG. 9 is a flow chart showing the picture file analysis action and the operation script change action performed by the wireless terminal device 200 in S503 of FIG. 8.

After reading the operation script from the memory 204 in S502 of FIG. 8, the CPU 203 acquires GUI update time corresponding to update time of the entire operation screen displayed on the liquid crystal display 201 (S601). For example, if the GUI is subjected to update processing at 30 fps (frames per second), the CPU 203 acquires 33 milliseconds as the update time.

After detecting the update time in S601 of FIG. 9, the CPU 203 detects the picture file written in the operation script (S602).

FIG. 10 is a diagram showing one example of an operation script received from the media server. This operation script describes one object included in the operation screen. For such an operation script, for example, the CPU 203 reads the operation script on an individual column basis. Then the CPU 203, based on the read column 701, detects the picture file. When the column 701 has been read, the CPU 203 detects the picture file compressed in the JPG format. The CPU 203 further reads the column 702 to thereby detect the display size of this picture file. After the picture file detection, the CPU 203 proceeds to processing of S602.

Next, the CPU 203, based on the update time detected in S601 and the processing speed information stored in the memory 204, changes the operation script (S603).

For example, assume that a size of the picture file is detected as “320×200” and the compression format is detected as the “JPG format” in S602. In S601, the update time is detected as 33 milliseconds, and therefore the CPU 203 changes the display size of this picture file so that the processing time of the picture file falls within 33 milliseconds. The CPU 203 can recognize, based on the processing speed information shown in FIG. 6, that 28 milliseconds are required for processing a picture file corresponding to 40000 pixels. Thus, the display size is reduced so that the picture file detected in S602 agrees with a picture file corresponding to 40000 pixels. In this case, the CPU 203 performs the reduction so that the display size of the picture file agrees with “253×158”. It is desirable that upon the picture reduction by the CPU 203, a horizontal to vertical ratio of the picture file do not change as a result of the reduction.

Therefore, the CPU 203 changes the operation script so that the column 702 has [“width”:253] and [“height”:158].

The CPU 203 reads in all the columns of the operation script acquired from the media server 100 and determines whether or not the analysis has ended (S604), and if all the operation script read-in and analysis has completed (Yes in S604), the CPU 203 proceeds to the processing of S504 shown in FIG. 8. If the operation script read-in and analysis have not completed (No in S604), the CPU 203 proceeds to the processing of S602 to detect the picture file again.

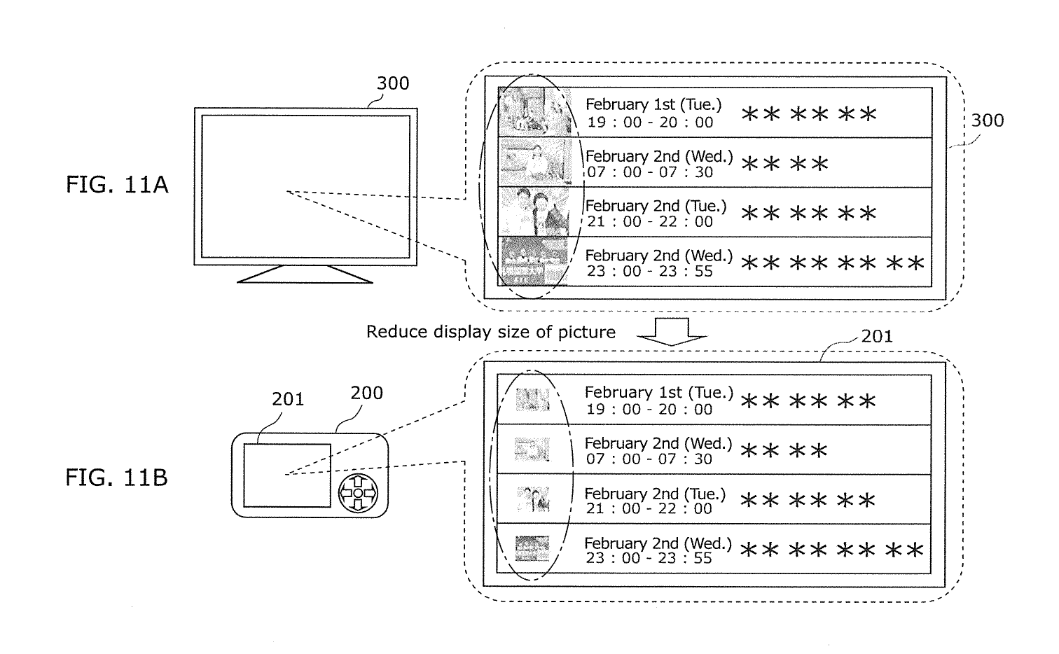

As described above, by changing the operation script, not only the entire operation screen is downsized from a size of a display region of the TV monitor 300 to a size of a display region of the liquid crystal display 201 of the wireless terminal device 200, but also for the object of the picture file, the display size is reduced so that picture update is completed within the update time of the operation screen. This therefore provides effect that even the wireless terminal device 200 with poor hardware resources can clearly display the picture file in the operation screen. FIGS. 11A and 11B are diagrams showing one example of operation screens before and after the display size of the picture file is changed by the script conversion unit 213. FIG. 11A shows one example of the operation screen displayed on the TV monitor 300 by directly executing the operation script from the media server 100. FIG. 11B shows one example of the operation screen displayed on the liquid crystal display 201 of the wireless terminal device 200 by executing the operation script after the change of the display size by the wireless terminal device 200. Here, the object described by the operation script shown in FIG. 10 corresponds to one of pictures surrounded by a chain line within the operation screen shown by a blow-out shot of FIG. 11A. As shown in FIG. 11B, executing the operation script changed by the script conversion unit 213 not only downsizes the entire operation screen in accordance with the display size of the liquid crystal display 201 but also displays only a portion of pictures surrounded by a chain line on a reduced scale compared to the entire operation screen.

### Second Embodiment

In the first embodiment described above, in S601 of FIG. 9, the CPU 203 acquires, from the description of the operation script, the GUI update time as the update time of the entire operation screen displayed on the liquid crystal display 201. On the contrary, in the second embodiment, as update time for determining the display size of the picture file, update time for each picture file may be acquired.

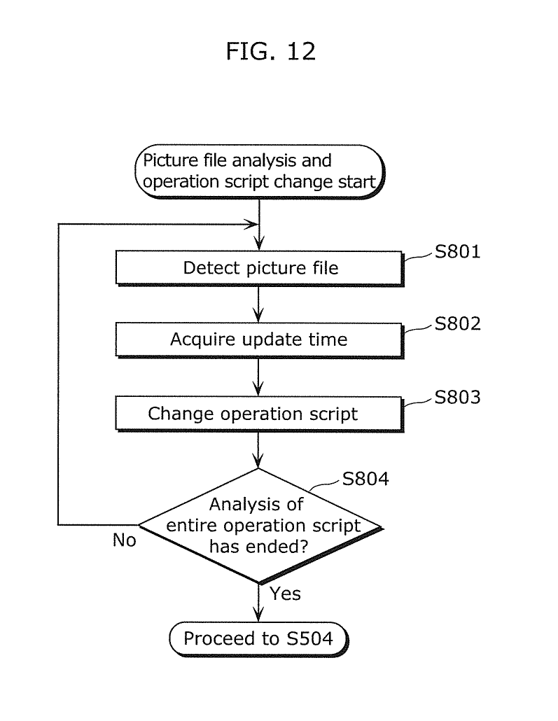

FIG. 12 is a flow chart illustrating action of acquiring the update time for each picture file and determining the display size of the picture file by the CPU 203.

After reading out the operation script in S502 shown in FIG. 8, the CPU 203 detects the picture file described in the operation script (S801). The picture file detection action is the same as that of S602 illustrated in FIG. 9, and thus its detailed description will be omitted.

After the picture file detection, the CPU 203 acquires the update time for each detected picture file (S802). The CPU 203 can acquire this update time from contents described in the received operation script. Moreover, the CPU 203 may be configured to acquire the update time based on a compression format of the picture file. The update time may be previously defined for each compression format of the picture file so that, for example, in a case where the compression format of the picture file is the “JPEG”, the update time is 12 milliseconds for any size of the picture file.

Next, the CPU 203 changes the operation script based on the update time detected in S802 and the processing speed information stored by the memory 204 (S803).

For example, assume that the size of the picture file is detected as “320×200” and the compression format is detected as the “JPG format” in S802. Also assume that the update time of the picture file is detected as 12 milliseconds in S802. In this case, the CPU 203 changes the display size of this picture file so that processing time of the picture file falls within 12 milliseconds. The CPU 203, from the processing speed information shown in FIG. 6, recognizes that 10 milliseconds of processing time is required for processing the picture file corresponding to 10000 pixels. Thus, the CPU 203 reduces the display size so that the picture file detected in S802 agrees with a picture file corresponding to 10000 pixels. In this case, the CPU 203 performs the reduction so that the display size of the picture file agrees with “125×78”. It is preferable that upon the picture file reduction by the CPU 203, a vertical to horizontal ratio of the picture file do not change as a result of the reduction.

Therefore, the CPU 203 changes the operation script so that the column 702 has [“width”:125] and [“height”:78].

The CPU 203 determines whether or not analysis of the entire operation script acquired from the media server 100 has ended (S804). If the analysis of the entire operation script has completed (Yes in S804), the CPU 203 proceeds to the processing of S504. If the analysis of the entire operation script has not completed (No in S804), the CPU 203 proceeds to processing of S801 to detect the picture file again.

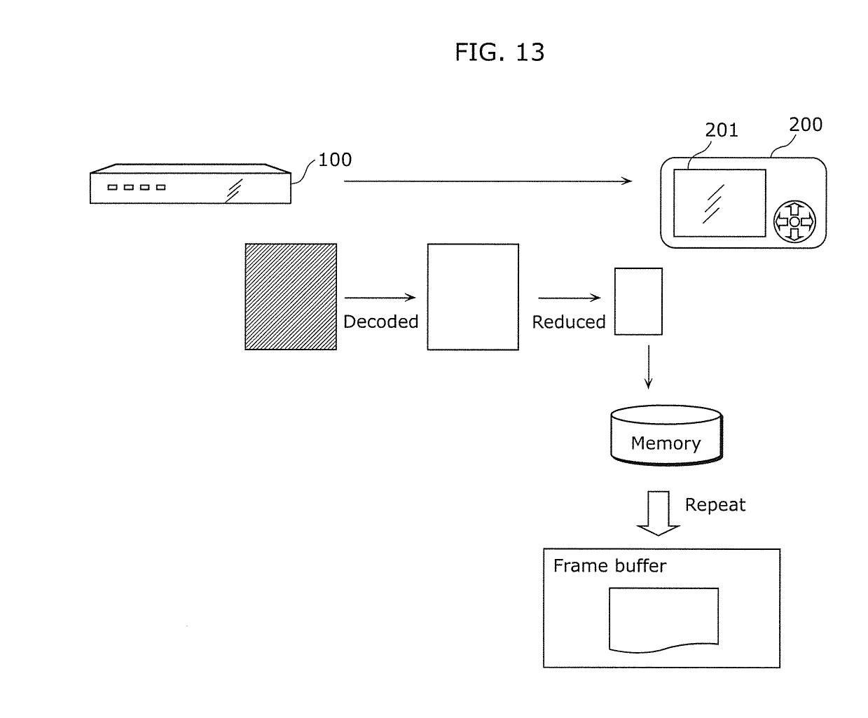

FIG. 13 is a diagram schematically showing detailed procedures of operation script conversion processing in the wireless terminal device 200. As shown in the figure, from the media server 100 to the wireless terminal device 200, a compressed and encoded operation script is transmitted. This operation script is created on the assumption that it is displayed on the screen of the TV monitor 300, and includes a picture file. On the contrary, in the wireless terminal device 200, to display the operation screen as the GUI on the liquid crystal display 201 based on the received operation script, the received operation script is decoded and the decoded operation script is further downsized by the method of the first embodiment or the second embodiment. Specifically, the display size of the entire operation screen is reduced in accordance with the display size of the liquid crystal display 201, and the display size of the picture file is reduced so that update time of the picture file falls within the update time of the operation screen or update time for each picture file. The operation script already subjected to the conversion as described above is stored as bitmap data into the memory 204. The bitmap data of the operation script stored in the memory 204 is, for each operation script update time, repeatedly written into the frame buffer and is also displayed on the liquid crystal display 201, refreshing the display of the liquid crystal display 201. As described above, the CPU 203 downsizes the received operation script so that it agrees with the display size of the liquid crystal display 201, downsizes the picture file so that the operation screen update can be done within the update time defined by the operation script, and then stores the bitmap data of the operation screen into the memory 204. As a result, in the wireless terminal device 200, before an initial screen is displayed, processing time for reducing the picture file is required, but provided is effect that a storage region of the memory 204 for storing the bitmap data of the operation screen can be saved and that speed of processing of repeatedly reading the bitmap data of the operation screen from the memory 204 and writing it into the frame buffer (rectangular transfer or bitblit processing) can be increased and processing load of the CPU 203 can be reduced.

### Third Embodiment

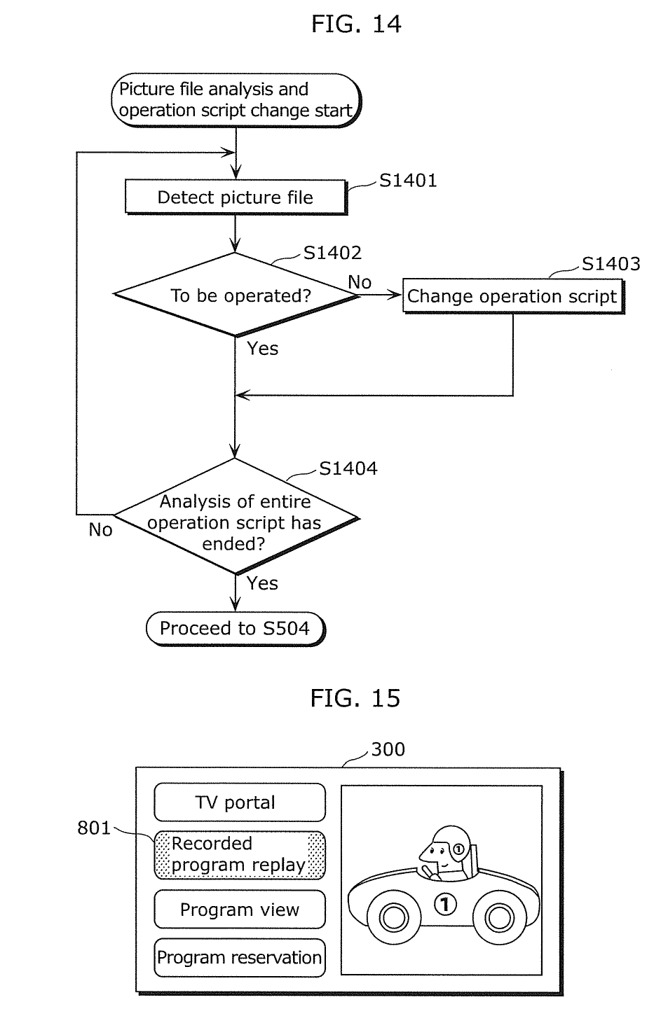

FIG. 14 is a flow chart showing picture file analysis action and operation script change action in a wireless terminal device according to the third embodiment. In the wireless terminal device 200 according to the third embodiment, after the processing of the first or second embodiment is performed, it is further determined whether or not the object detected as the picture file is an object to be operated, and if the objected is an object other than the object to be operated, the operation script is changed so that this object is displayed on a more reduced scale than the object to be operated. After the operation script is read from the memory 204 in S502 shown in FIG. 8, the CPU 203 detects the picture file written in the operation script (S1401). This processing is the same as the processing of S601 shown in FIG. 9.

Next, the CPU 203 detects, based on description of the read operation script, whether or not an object corresponding to the picture file detected in S1401 is to be operated (S1402). Note that a method of detecting whether or not the object corresponding to the picture file is to be operated is not limited to the configuration described above, and a conventionally used method may be used. If the object corresponding to the picture file is not to be operated (No in S1402), the processing proceeds to S1403. On the other hand, if it has been detected that the object corresponding to the picture file is to be operated, the processing proceeds to S1404. Processing of S1404 is the same as the processing of S604 shown in FIG. 9.

If it has been detected that the object corresponding to the picture file is not to be operated (No in S1402), the CPU 203 changes the operation script so that this picture file is displayed on a reduced scale (S1403). More specifically, the CPU 203 changes the operation script so that the display size of the picture file is reduced by 10%. That is, the CPU 203 changes the operation script so that the column 702 shown in FIG. 10 has [“width”:320*(1−0.1)] and [“height”:200*(1−0.1)].

The CPU 203 determines whether or not analysis of the entire operation script has completed (S1404), and if the analysis of the entire operation script has completed (Yes in S1404), the CPU 203 proceeds to the processing of S504 of FIG. 6. If the analysis of the entire operation script has not completed (No in S1404), the CPU 203 proceeds to S1401 to detect the picture file again.

FIG. 15 is a diagram showing one example of a GUI displayed on a TV monitor in a case where the unchanged operation script is executed. As shown in the same figure, in the case where the unchanged operation script is executed, displayed on the TV monitor 300 are four operation buttons including: “TV portal”, “Programmed program replay”, “Program viewing” and “Program reservation”, all of which are displayed in the same size. Of these, an object 801 as the “Programmed program replay” is currently in a selected state, and if it is the object is to be operated, the object 801 is displayed in a colored manner. The selected state is a state in which the object to be operated is specified, and a state in which the object in the selected state is displayed on the TV monitor 300, and for example, when the determine button of the remote controller 5 has been pressed, a command for commanding action of “Recorded program replay” corresponding to the object 801 as the object to be operated is executed in the media server 100. For the unchanged operation script, a device that executes the operation script is the media server 100 with enough hardware resources, and thus both the object to be operated and the object not to be operated are displayed in the same display size.

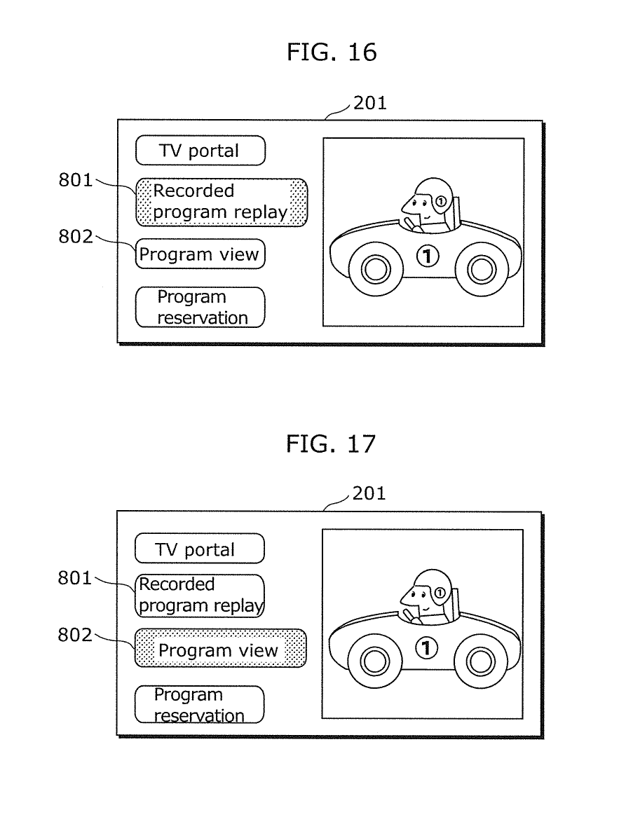

FIG. 16 is a diagram showing one example of a GUI displayed on the liquid crystal display in a case where the changed operation script is executed. FIG. 17 is a diagram showing one example of a GUI displayed on the liquid crystal display in a case where the object to be operated has been changed to a different object.

For the example of the GUI shown in FIG. 15, for example, in a case where the object 801 is an object to be operated, the CPU 203 of the wireless terminal device 200 changes the operation script so that it turns into the GUI shown in FIG. 16. In FIG. 16, the entire operation screen shown by the unchanged operation script is downsized in accordance with the display size of the liquid crystal display 201. Further, display sizes of all the picture objects included in the operation script are reduced so that the picture objects can be updated within the update time of the operation screen. Furthermore, in the wireless terminal device 200 according to the third embodiment, all the objects other than the object 801 as the object to be operated are displayed on a reduced scale. In a case where the determine button of the operation member 202 has been pressed in a state in which the GUI is displayed on the liquid crystal display 201 as described above, a control signal corresponding to the object 801 is transmitted to the media server 100 via the wireless rooter 3, and the command for commanding the processing of “Recorded program replay” is executed in the media server 100.

In FIG. 16, all the objects other than the object 801 are downsized, but the invention is not limited to this, and thus the operation script may be changed so that only some of the objects other than the object to be operated are downsized. The same also applies to FIG. 17.

Upon transition of the object to be operated from the object 801 to an object 802 as a result of operating, for example, either of the up and down keys of the operation member 202 in the state in which the operation screen shown in FIG. 16 is displayed, the CPU 203 changes the operation script accumulated in the memory 204 to an operation script such that a GUI shown in FIG. 17 is displayed on the liquid crystal display 201. More specifically, the display size of the object 801 to be operated on the operation screen shown in FIG. 16 is reduced to the same size as those of the other objects on the operation screen of FIG. 16, and coloring of the object 801 is changed to the same color of the other objects. Further, the operation script is changed so that the display size of the object 802 as the new object to be operated becomes equal to the display size of the object 801 on the operation screen shown in FIG. 16 and the object 802 is colored in the same color as that of the object 801. In this case, if the operation script has been changed so that the objects other than the object 801 are downsized with respect to the object 801 by 10%, the CPU 203 changes the operation script so that the display size of the object 801 becomes equal to those of these objects, for example, it has [“width”:320*(1−0.1)] and [“height”:200*(1−0.1)] as in the column 702 shown in FIG. 10. On the contrary, the CPU 203 changes the operation script so that for the object 802 that has been downsized by 10% on the operation screen shown in FIG. 16, the display size of the object 802 agrees with the unreduced display size with ([“width”:320] and [“height”:200].

In a case where the determine button of the operation member 202 has been pressed in a state in which the GUI of FIG. 17 is displayed on the liquid crystal display 201 as described above, a control signal corresponding to the object 802 is transmitted to the media server 100 via the wireless rooter 3, and a command for commanding processing of “Program viewing” is executed in the media server 100.

The configuration described above permits the wireless terminal device 200 to change the operation script so that some of the objects other than the object to be operated are displayed on a reduced scale. This makes it possible for the wireless terminal device 200 to promptly execute the operation script of the media server 100 while maintaining the display size of the object to be operated.

In the third embodiment, after the operation script for the TV monitor 300 received from the media server 100 is downsized in accordance with the display size of the liquid crystal display 201 of the wireless terminal device 200, the display size of the picture file is reduced so that the picture file included on the operation screen can be updated within the update time of the operation screen, and the operation script is further changed so that the display sizes of the objects other than the object to be operated are displayed on a smaller scale than that of the object to be operated. However, the invention is not limited to this, and for example, only the object to be operated may not be downsized to the display size that permits update within the update time of the operation screen, but may be slightly downsized so that the display size of the object to be operated becomes larger than those of the other objects although update of the object to be operated may be delayed behind that of the other objects. Alternatively, the display sizes are not reduced although there is possibility that only the display of the object to be operated cannot be done within the update time of the operation screen. This consequently permits the object to be operated to be displayed on a larger scale and can favorably maintain visibility and operability of the operation buttons.

### Fourth Embodiment

In the fourth embodiment of the invention, the operation script is changed so that not only the display size of the picture file included in the operation script is reduced to a display size that permits update within the update time of the operation screen, but also in accordance with a method of processing the picture file corresponding to the object not to be operated, this object is displayed on an even more reduced scale. The picture file processing method according to the fourth embodiment corresponds to a picture file decoding processing method, and the operation script is changed in accordance with whether the decoding processing is performed by hardware or software. Whether the encoded picture file is to be decoded by the hardware or the software can be determined by referring to device information of the wireless terminal device 200 which information is stored in the memory 204.

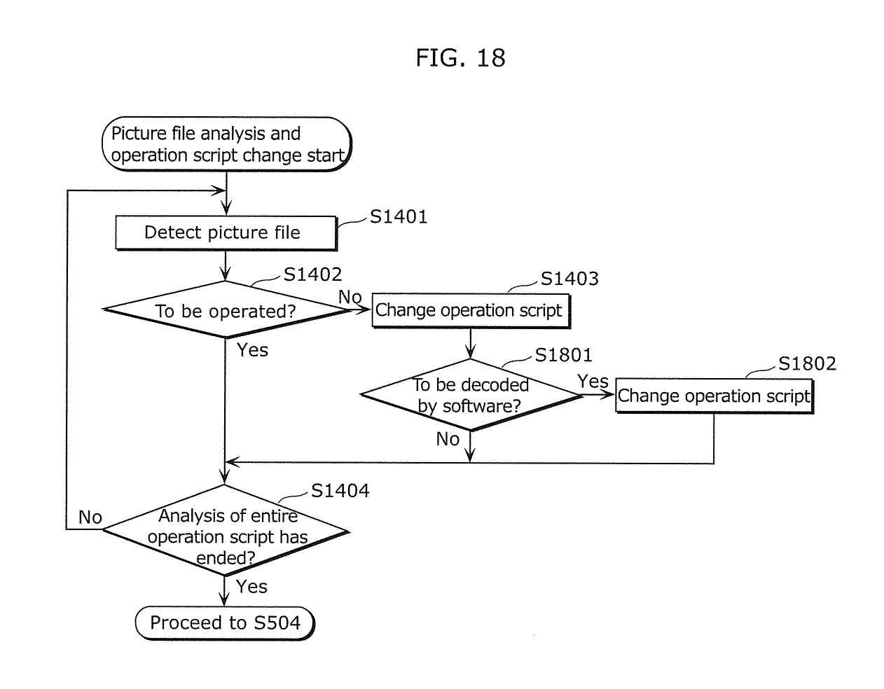

FIG. 18 is a flow chart showing picture file analysis action and operation script change action in the wireless terminal device according to the fourth embodiment. The same steps as those of FIG. 14 are provided with the same step numbers and their detailed description will be omitted.

After the operation script of the picture file corresponding to the object not to be operated is changed in S1403 of FIG. 18, the CPU 203 detects whether or not the picture file included in the operation script is decoded by the software (S1801). If this picture file is decoded by the software (Yes in S1801), the processing proceeds to S1802, and if the picture file is decoded by a method other than that using the software (No in S1801), the processing proceeds to S1401.

If it has been detected that the picture file is decoded by the software (Yes in S1801), the CPU 203 changes the operation script so that this picture file is displayed on an even more reduced scale (S1802). For example, the CPU 203 changes the operation script so that the display size of this picture file is further reduced by 10%. That is, the CPU 203 changes the operation script so that the column 702 has, for example, [“width”:320*(1−0.2)] and [“height”:200*(1−0.2)]. After the operation script is changed, the processing proceeds to S1404.

Configuring the script conversion unit 213 of the wireless terminal device 200 as described above makes it possible to even more promptly execute the operation script for controlling the controlled device (media server 100) while maintaining the display size of the object to be operated in the changed operation script. In the fourth embodiment, the operation script is changed so that the objects other than the object to be operated are reduced by 10%, and if the object is decoded by the software, the operation script is changed so that the changed display size is further reduced by 10%. However, the invention is not limited to this, and a ratio by which the object included in the operation script is reduced is not necessarily 10% but it may be reduced by a predefined ratio. Moreover, in the fourth embodiment described above, if the picture file included in the operation script is the object other than the object to be operated, the original display size is multiplied by (1−0.1), and if the more reduced picture file is decoded by the software, the original display size is multiplied by (1−0.2) to thereby calculate the reduced display size, but a formula for calculating the reduced display size is not limited to this. For example, if there is any picture, other than the object to be operated, decoded by the software, the original display size may be multiplied by (1−0.1)*(1−0.1), or calculation may be further done by a different calculation formula. Note that various variations as described above are permitted for the formula for calculating the reduced display size of the picture file, which also applies to embodiments described below.

### Fifth Embodiment

In the fifth embodiment, the operation script is changed so that not only the display size of the picture file included in the operation script is reduced to the display size that permits the update within the update time of the operation screen, but also in accordance with a compression format of the picture file corresponding to the object not to be operated, this object is displayed on an even more reduced scale. The compression format of the picture file according to the fifth embodiment refers to a compression format of a stationary picture such as a PNG format, a JPG format, or a GIF format, and illustrated here is one example of changing the operation script in accordance with whether or not the picture file is compressed in the PNG format. These compression formats can be detected based on an extension provided to a file name of the picture file.

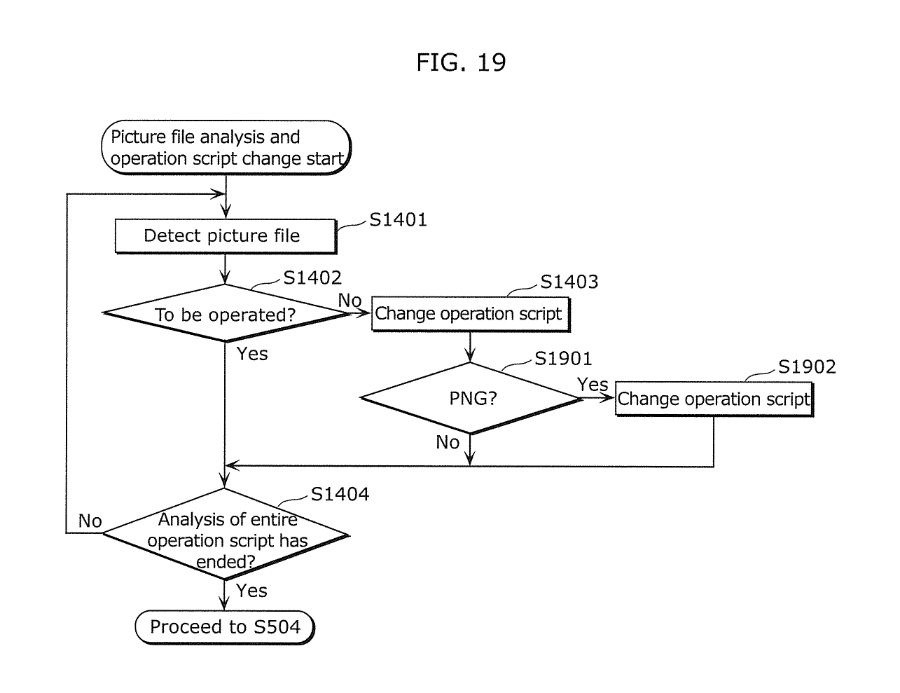

FIG. 19 is a flow chart showing picture file analysis action and operation script change action in a wireless terminal device according to the fifth embodiment. The same steps as those of FIG. 14 are provided with the same step numbers and their detailed description will be omitted.

After the operation script of the picture file corresponding to the object not to be operated is changed in S1403 of FIG. 19, the CPU 203 detects whether or not the compression format of this picture file is the PNG format (S1901). If this picture file is compressed in the PNG format (Yes in S1901), the processing proceeds to S1902, and if the picture file is compressed in the compression format other than the PNG format (No in S1901), the processing proceeds to S1404.

If it has been detected that the picture file included in the operation script is compressed in the PNG format (Yes in S1901), the CPU 203 changes the operation script so that this picture file is displayed on an even more reduced scale (S1902). For example, the CPU 203 changes the operation script so that the display size of this picture file is further reduced by 10%. That is, the CPU 203 changes the operation script so that the column 702 has, for example, [“width”:320*(1−0.2)] and [“height”:200*(1−0.2)]. After the operation script is changed, the processing proceeds to S1404.

Configuring the script conversion unit 213 as described above makes it possible to even more promptly execute the operation script for controlling the controlled device while maintaining the display size of the object to be operated in the changed operation script.

### Sixth Embodiment

Further, in the sixth embodiment, the operation script is changed so that not only the display size of the picture file included in the operation script is reduced to the display size that permits the update within the update time of the operation screen, but also for the objects not to be operated, the object is displayed on an even more reduced scale in accordance with overlapping between the objects on the operation screen. Specifically, the operation script of the picture file is changed so that the object which is not to be operated and which is displayed behind the different object with its part hidden by the different object is displayed on a more reduced scale.

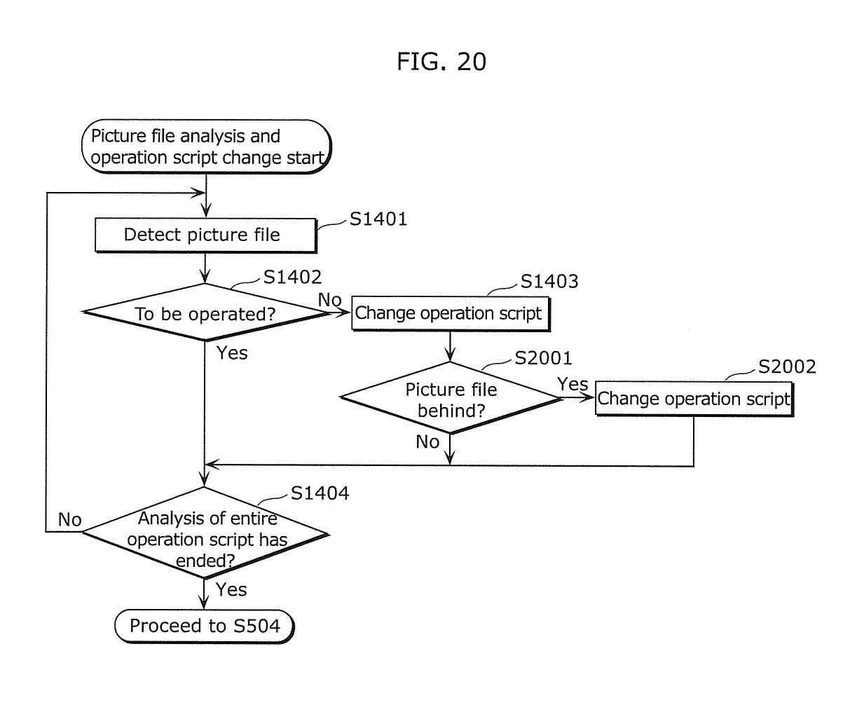

FIG. 20 is a flow chart showing picture file analysis action and operation script change action in a wireless terminal device 200 according to the sixth embodiment. The same steps as those of FIG. 14 are provided with the same step numbers and their detailed description will be omitted.

In S1403 of FIG. 20, after the operation script of the picture file corresponding to the object other than the object to be operated is changed, the CPU 203 detects whether or not this picture file overlaps with the different picture file and is also displayed behind the different picture file (S2001). If the picture file overlaps with the different picture file and is also displayed behind the different picture file (Yes in S2001), the processing proceeds to S2002. In cases other than the case described above (No in S2001), the processing proceeds to S1404.

If it has been detected that the picture file overlaps with the different picture file and is also displayed behind the different picture file (Yes in S2001), the CPU 203 changes the operation script so that this picture file is displayed on an even more reduced scale (S2002). More specifically, the CPU 203 changes the operation script so that the display size of this picture file is further reduced by 10%. That is, the CPU 203 changes the operation script so that the column 702 has [“width:320*(1−0.2)] and [”height“:200*(1−0.2)]. After the operation script is changed, the processing proceeds to S1404.

Configuring the script conversion unit 213 as described above makes it possible to display the object, which is not to be operated and which is displayed behind the different object and whose contents do not have to be checked by the user, on an even more reduced scale while maintaining the display size of the object to be operated in the wireless terminal device 200 of this embodiment. Thus, it is possible to even more promptly execute the operation script for controlling the media server 100 as the controlled device without damaging operability of the user.

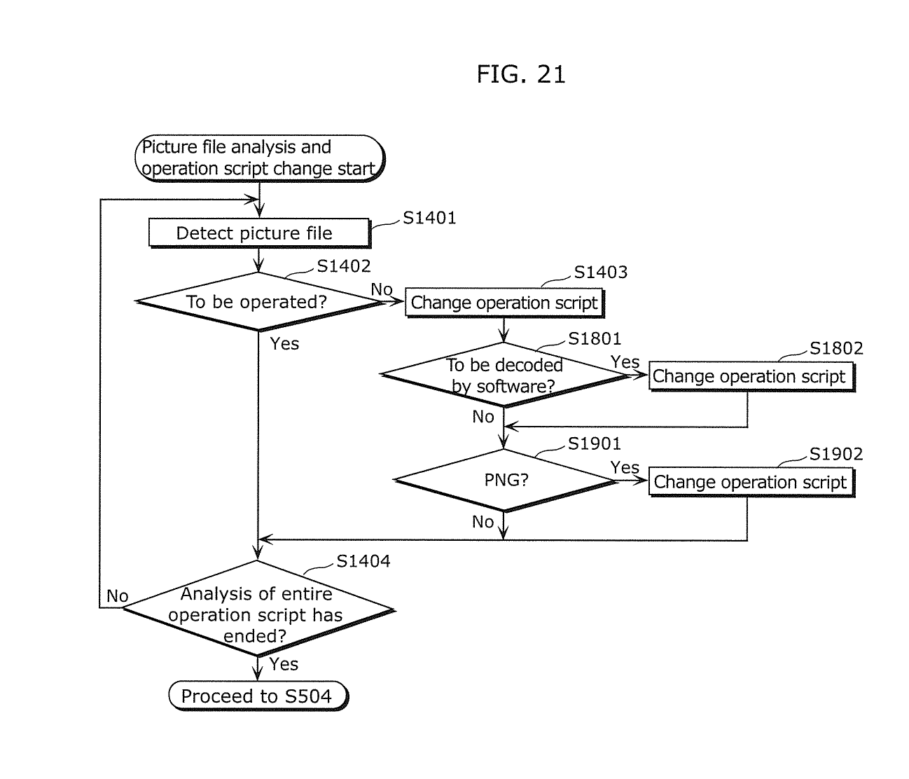

The invention is not limited to the embodiments described above, and thus can be realized by, for example, configuration obtained by combining together the fourth and fifth embodiments as shown in FIG. 21. In this case, the CPU 203 changes the operation script so that the display size of the picture file to be decoding by software by the processing in S1802 of FIG. 21 is reduced, and then if the same picture file is in the PNG format, changes the operation script so that the display size of the picture file is further reduced by the processing in S1902. For example, in the processing of S1403, for the object not to be operated, the display size of the picture file is calculated by multiplying vertical and horizontal lengths by (1−0.1). Then if this object is to decoded by software, it is further multiplied by (1−0.1) to reduce the display size of the picture file in the processing of S1802. Moreover, if this object is in the PNG format, it is further multiplied by (1−0.1) to reduce the display size of the picture file in the processing of S1902. Note that the object display size calculation method described above is just one example, and it is needless to say that the display size of the picture file may be calculated by use of a numerical value and a formula different therefrom, which also applies to the embodiments described below.

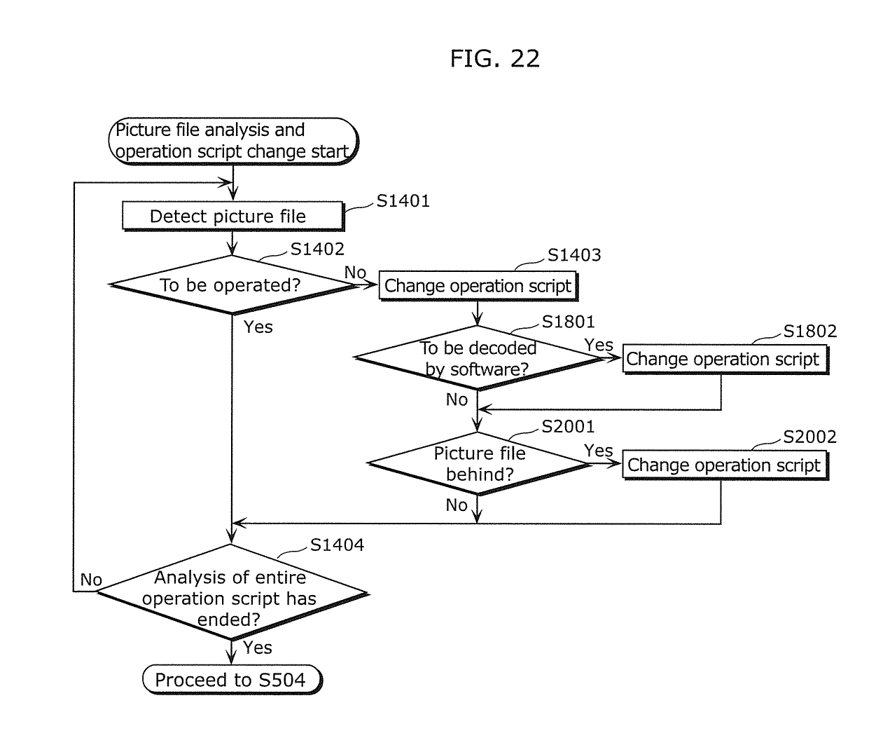

Moreover, the invention can also be realized with configuration obtained by combining together the fourth and sixth embodiments as shown in FIG. 22.

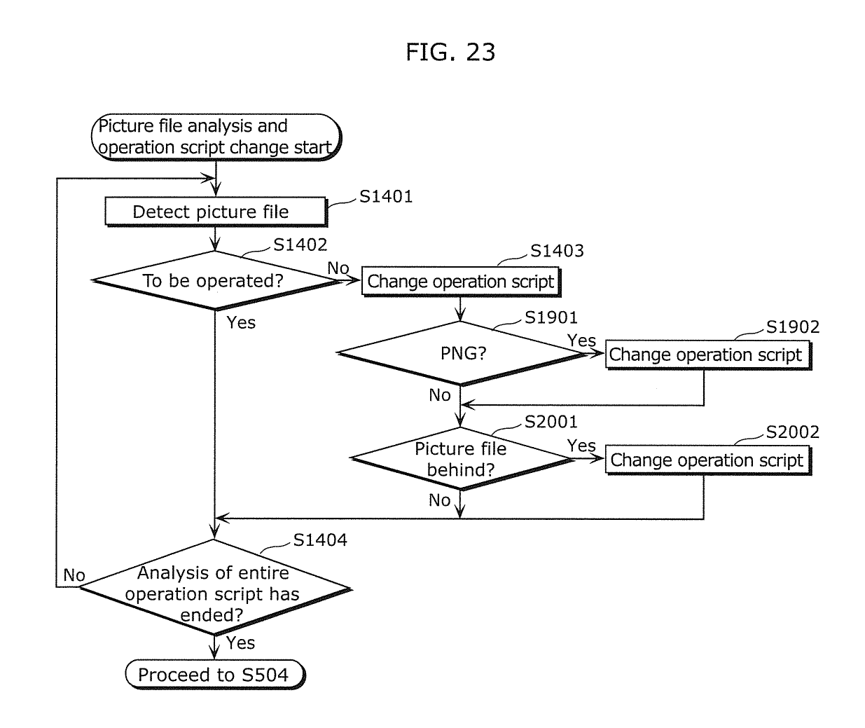

Moreover, the invention can be realized with configuration obtained by combining together the fifth and sixth embodiments as shown in FIG. 23.

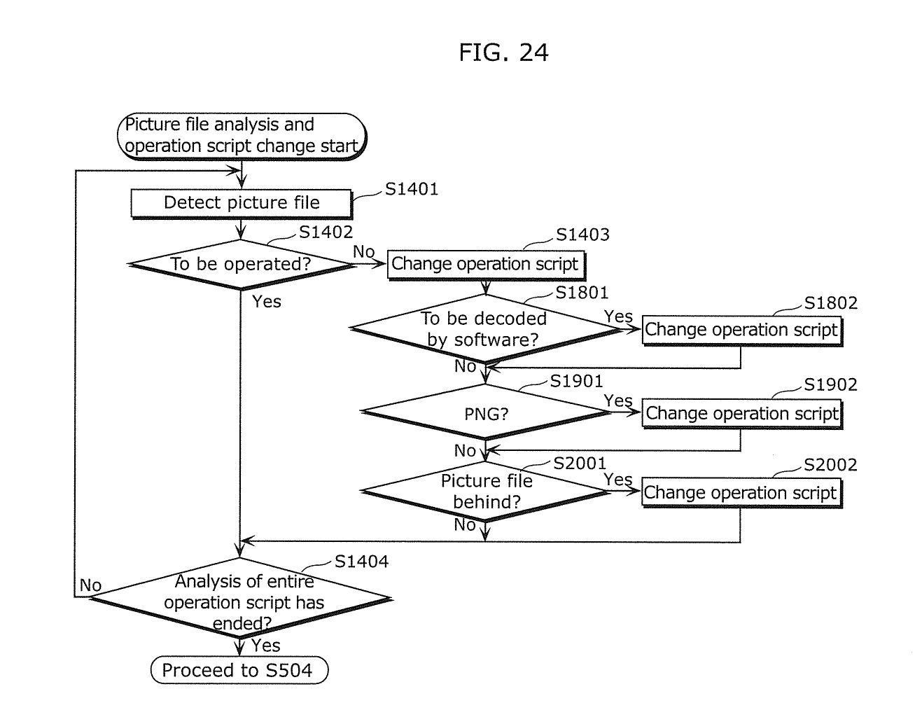

Moreover, the invention can be realized with configuration obtained by combining all the fourth to sixth embodiments as shown in FIG. 24.

Further, the configurations obtained by arbitrarily combining together the fourth to sixth embodiments are each combined with the first embodiment, and the invention is not limited thereto and it is needless to say that these configurations may be combined with the second embodiment. The same also applies to the embodiments described below.

In the fourth to sixth embodiments described above, for the object within the operation screen defined by the operation script, it is determined, for each of conditions, to which condition the object applies, and every time the object applies to the predetermined condition, the operation script is changed so that the display size of this object is reduced by a fixed ratio. However, the invention is not limited thereto, and for example, for each predetermined condition, a degree of significance of the object applying to this condition may be previously defined, for each operation screen, the degree of significance of each object may be calculated, the calculated degree of significance and a threshold value may be compared to each other, and the display size of the object may be reduced only when the degree of significance is lower than the threshold value. For example, defining the degree of significance of the object not to be operated as “0.5”, the degree of significance of the object to be decoded by the software as “0.8”, the degree of significance of the object displayed behind the different object as “0.7”, and the degree of significance of the object in the PNG format as “0.6”, the degree of significance on each operation screen is calculated for each object. For example, the degree of significance of the object which is not to be operated on the given operation screen, which is in the PNG format, and which is displayed behind the different object is calculated as 0.5*0.6*0.7=0.21. Such calculation provides effect that the determination through the comparison between the degree of significance and the threshold value is done only once for each object. That is, in a case where the threshold value is “0.3” and the display size of the object whose degree of significance is equal to or lower than the threshold value is to be reduced on this operation screen, it can be determined through one threshold value comparison that this object is subject to display on a reduced scale.

Moreover, if the degree of significance of the object is lower than the threshold value, a ratio by which the display size of this object is reduced may be defined as a value in accordance with the degree of significance. For example, in the example described above, the degree of significance of the object is “0.21” and thus is lower than the threshold value “0.3”. Therefore, this object is subjected to the reduced display, and the ratio of this reduction may be, for example, 0.21 times the original display size.

### Seventh Embodiment

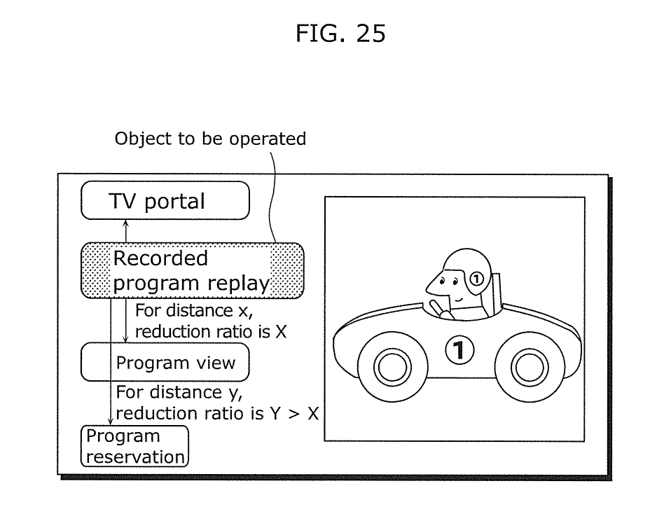

FIG. 25 is a diagram showing one example of an operation screen displayed on the liquid crystal display as a result of changing the operation script in a wireless terminal device according to the seventh embodiment. The wireless terminal device 200 according to the seventh embodiment not only reduces the display size of the picture file included in the operation script to the display size that permits the update within the update time of the operation screen, but also, if the picture file indicates the object not to be operated, reduces the display size of this picture file so that with an increase in distance between display position of this object and display position of the object to be operated, the display size decreases in accordance with this distance.

When the operation script changed in this manner is executed, as shown in FIG. 25, the object separated more distantly from the “Recorded program replay” button as the object to be operated is displayed in a smaller display size. That is, the case of FIG. 25 shows configuration such that a reduction ratio increases with an increase in the distance from the object to be operated. More specifically, a “TV portal” button and a “Program view” button as the objects displayed at position separated from the “Recorded program replay” button by distance X are displayed in the same display size. Moreover, the “Program reservation” button as the object displayed at position separated from the “Recorded program replay” button by distance Y (Y>X) is displayed in a size smaller than that of the “TV portal” button and the “Program view” button displayed more closely to the “Recorded program replay” button than this “Program reservation” button.

Typically, in the operation script displaying the GUI, in order that the objects such as the operation buttons composing the GUI are displayed with appropriate arrangement as designed, display position of each of the objects is written by use of coordinates. Also on the TV monitor 300 and the liquid crystal display 201 of the wireless terminal device 200, for example, the coordinates are set with a left top corner of a display region as reference coordinates (0, 0), and the coordinates written in the operation script are associated with the coordinates set in the display region, thereby making it possible to display the operation screen defined by the operation script on a display device such as the TV monitor 300. As described above, written in the operation script by use of the coordinates is the display position of each object, and thus distance between the objects can also be calculated by use of the coordinates.

In the wireless terminal device 200 according to the seventh embodiment, for example, a table indicating ratios of reducing the display size of the picture file with respect to the distance between the displayed objects is stored in the memory 204. For example, stored in the memory 204 is a table with written contents such that if distance x from the object to be operated is 0 to 99, vertical and horizontal display sizes of the object are each reduced in a reduction ratio X equal to 0.9X, and if the distance x is 100 to 199, the reduction ratio X is set at 0.8X, and if the distance x is 200 to 299, the reduction ratio X is set at 0.7X, and if the distance x is 300 or above, the reduction ratio is set at 0.5X. The CPU 203 first reduces the display size of the entire operation screen so as to achieve adaptation from the display size of the TV monitor 300 to the display size of the liquid crystal display 201, and reduces the display size of the picture file included in the reduced operation screen to a size that permits the update within the update time of the operation screen. Then for each object not to be operated, the distance x from the object to be operated is calculated, and by referring to the table of the memory 204, the display size of the object is reduced in accordance with the distance from the object to be operated. The invention is not limited to a method of previously storing the table as described above into the memory 204, but permitted configuration is such that a reduction ratio is calculated based on the distance from the object to be operated on a case-by-case basis to set the reduction ratio for the display size of the object. For example, a predefined reduction ratio corresponding to reference distance may be stored and in accordance with the calculated distance, computation such as proportional division is performed on the stored reduction ratio to dynamically determine the reduction ratio for each object.

With the configuration described above, the wireless terminal device 200 as a control terminal device that controls the media server 100 as a controlled device can execute the operation script without delaying processing of displaying the picture file included in the operation script.

The embodiments described above may be carried out in any combination. Moreover, the detailed examples of the first to seventh embodiments have been described by use of numerical values, but the numerical values used in the embodiments described above are just illustrative and the invention is not limited to these numerical values.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

Display devices such as blue-ray recorders and digital TVs according to the invention are useful as, for example, methods of processing (such as graphic processing) GUI information in a remote UI function between devices with different display capabilities and methods of displaying the GUI information.

What is claimed is:

1. A control terminal device comprising:
a receiving unit configured to receive an operation script defining an operation screen;
a script conversion unit configured to reduce a display size of an object as a component of the operation screen defined by the operation script, and
a determination unit configured to read from the operation script the display size of the object and update time of the operation screen, and determine whether or not display of the object in the display size can be completed within the update time,
wherein said script conversion unit is configured to reduce the display size of the object the display of which in the display size is determined not to be completed within the update time.

2. The control terminal device according to claim 1,
wherein said determination unit is further configured to determine whether or not a degree of significance of the object is equal to or lower than a threshold value, and
said script conversion unit is further configured to reduce the display size of the object whose degree of significance is determined to be equal to or lower than the threshold value.

3. The control terminal device according to claim 2,
wherein said determination unit is configured to, for each of the object or for each extension of a file indicating the object, read the predefined degree of significance from a memory and compare the read degree of significance with the threshold value to determine whether or not the degree of significance of the object is equal to or lower than the threshold value.

4. The control terminal device according to claim 2,
wherein said determination unit is configured to, for each of the object or for each extension of a file indicating the object, receive the predefined degree of significance together with the operation script and compare the received degree of significance with the threshold value to determine whether or not the degree of significance of the object is equal to or lower than the threshold value.

5. The control terminal device according to claim 2,
wherein said determination unit is configured to, for each of the object or for each extension of a file indicating the object, read from a memory the degree of significance defined by inputting by a user and compare the read degree of significance with the threshold value to determine whether or not the degree of significance of the object is equal to or lower than the threshold value.

6. A control terminal device comprising:
a receiving unit configured to receive an operation script defining an operation screen;
a script conversion unit configured to reduce a display size of an object as a component of the operation screen defined by the operation script,
a memory configured to store, for each kind of the object, processing speed information indicating correspondence between the display size of the object and processing time required for displaying the object; and
a determination unit configured to, by referring to the processing speed information, determine whether or not display of the object in the display size defined by the operation script can be completed within update time defined by the operation script,
wherein said script conversion unit is configured to reduce the display size of the object the display of which in the display size is determined not to be completed within the update time.

7. The control terminal device according to claim 1,
wherein for the object, a degree of significance is defined for each condition to which the object applies,
said determination unit is further configured to, when the degree of significance of the object is equal to or lower than a threshold value, determine to reduce the display size of the object, and select, as the display size of the object, a second display size smaller than a first display size defined by the operation script, and
said script conversion unit is configured to change the display size of the object in the operation script to the second display size.

8. The control terminal device according to claim 7,
wherein said determination unit is configured to determine a kind of the object defined by the operation script, and when the object is a picture file, determine that the degree of significance of the object is lower than the threshold value.

9. The control terminal device according to claim 2,
wherein said determination unit is configured to, based on the operation script currently executed, when a plurality of the object are displayed as a plurality of options and one of the plurality of the object is highlighted for display indicating a selected state, determine that the object located closer to the object highlighted for display has a higher degree of significance and determine that the object located more distantly from the object has a lower degree of significance, and
said script conversion unit is configured to change the display size of the object in the operation script so that the object with the lower degree of significance has a smaller display size.

10. A control terminal device comprising:
a receiving unit configured to receive an operation script defining an operation screen;
a script conversion unit configured to reduce a display size of an object as a component of the operation screen defined by the operation script, and
a determination unit configured to determine whether or not a degree of significance of the object is equal to or lower than a threshold value, also read, from the operation script, update time of the object defined by the operation script, and select a second display size in which the display of the object is completed within the read update time,
wherein said script conversion unit is configured to reduce the display size of the object whose degree of significance is determined to be equal to or lower than the threshold value by changing the operation script so that the display size of the object whose degree of significance is determined to be equal to or lower than the threshold value agrees with the second display size.

11. A control terminal device comprising:
a receiving unit configured to receive an operation script defining an operation screen;
a script conversion unit configured to reduce a display size of an object as a component of the operation screen defined by the operation script, and
a determination unit configured to, when the operation screen is divided into a plurality of small regions and update time is individually defined for each of the small regions in the operation script, select a second display size in which display of the object included in each of the small regions can be completed within the update time defined for the corresponding small region,
wherein said script conversion unit is configured to change the operation script so that the display size of the object agrees with the second display size.

12. The control terminal device according to claim 7,
wherein said determination unit is configured to, when the object defined by the operation script is a picture decoded by software, determine that the degree of significance of the object is equal to or lower than the threshold value.

13. The control terminal device according to claim 7,
wherein said determination unit is configured to determine that the degree of significance of the object displayed behind the different object is equal to or lower than the threshold value.

14. A remote control system in which a controlled device and a control terminal device are connected,
wherein the controlled device includes: a script storage unit configured to store an operation script defining an operation screen of the controlled device; and a script transmission unit configured to, upon reception of a script transmission request requesting for transmission of the operation script from the control terminal device, read the operation script from the script storage unit and transmit the read operation script to the control terminal device,
the control terminal device includes: a receiving unit configured to receive the operation script from the controlled device; a script conversion unit configured to reduce a display size of an object as a component of the operation screen defined by the operation script; and a determination unit configured to read from the operation script the display size of the object and update time of the operation screen and determine whether or not display of the object in the display size can be completed within the update time, and
the script conversion unit is configured to reduce the display size of the object display of which in the display size is determined not to be completed within the update time.

15. A non-transitory computer-readable recording medium with a recorded program causing a computer to act as a control terminal device including: a receiving unit which receives from a controlled device an operation script defining an operation screen; a script conversion unit configured to reduce a display size of an object as a component of the operation screen defined by the operation script; and a determination unit configured to read from the operation script the display size of the object and update time of the operation screen and determine whether or not display of the object in the display size can be completed within the update time, wherein said script conversion unit is configured to reduce the display size of the object the display of which in the display size is determined not to be completed within the update time.
